(19) United States
(12) Patent Application Publication
(10) Pub. No.: US 2016/0309553 A1
(43) Pub. Date: Oct. 20, 2016

(54) CONTROLLING A LAMP HAVING AT LEAST TWO SEMICONDUCTOR LIGHT SOURCES

(71) Applicant: OSRAM GmbH, München (DE)

(72) Inventors: Ronny Kuerschner, Laaber (DE); Jens Richter, Painten (DE)

(21) Appl. No.: 15/038,077

(22) PCT Filed: Nov. 6, 2014
(86) PCT No.: PCT/EP2014/073953

§ 371 Date: May 20, 2016

(30) Foreign Application Priority Data
Nov. 20, 2013 (DE) 10 2013 223 711.1

(51) Int. Cl. H05B 33/08; B60Q 1/14; F21S 8/10; H05B 37/02

(52) U.S. Cl. CPC H05B 33/0815; H05B 37/0281; H05B 33/0845; B60Q 1/1423; F21S 48/115; F21Y 2101/02; F21Y 2101/025

(57) ABSTRACT

A control device for an illuminant having at least two semiconductor light sources and connectable to an electrical energy source, for converting an electrical power provided by the electrical energy source, by the semiconductor light sources, into an emitted light power dependent on the electrical power provided is disclosed. The semiconductor light sources are connected to the control device, and the control device is designed to set the electrical power provided by virtue of the control device including a clock generator designed to apply electrical power to the semiconductor light sources in clocked operation and to control said semiconductor light sources in accordance with clock pulse sequences individually assigned to the semiconductor light sources. The clock generator is designed to form a common pulse pattern from the clock pulse sequences and to set the light power emitted by the illuminant by selecting a pulse pattern assigned to the light power.

### TECHNICAL FIELD

The invention relates to a control device for an illuminant having at least two semiconductor light sources and connectable to an electrical energy source, for converting an electrical power provided by the electrical energy source, by means of the semiconductor light sources, into an emitted light power dependent on the electrical power provided, wherein the semiconductor light sources are connected to the control device, and the control device is designed to set the electrical power provided by virtue of the control device including a clock generator designed to apply electrical power to the semiconductor light sources in clocked operation. The invention furthermore relates to a lighting apparatus having an illuminant including a plurality of semiconductor light sources, an electrical terminal for connecting the lighting apparatus to an electrical energy source, and a control device, to which the semiconductor light sources are connected. Furthermore, the invention relates to a method for controlling an illuminant including at least two semiconductor light sources and connected to an electrical energy source, wherein the illuminant converts an electrical power provided by the electrical energy source, by means of the semiconductor light sources, into an emitted light power dependent on the electrical power provided, the electrical power provided is set by means of a control device by virtue of electrical power being applied to the semiconductor light sources in clocked operation by means of the control device, wherein the semiconductor light sources are controlled in accordance with clock pulse sequences individually assigned to the semiconductor light sources. Finally, the invention also relates to a computer program product.

### PRIOR ART

Illuminants of the generic type and control devices therefor and methods for controlling them are known extensively in principle in the prior art, and so there is no need for separate documentary evidence of this. Illuminants of the generic type are used for lighting purposes, inter alia, for example illumination of rooms, of work surfaces or the like. Furthermore, such illuminants are also increasingly being used in vehicles, for example as headlights or the like. The illuminant of the generic type includes a plurality of semiconductor light sources that are driven accordingly for achieving a desired lighting effect by means of the control device. For this purpose, the semiconductor light sources are connected to the control device. The semiconductor light sources are at the same time also supplied with electrical energy from the control device, such that the semiconductor light sources generate light according to the electrical energy fed to them. In this case, the light power generated is dependent, inter alia, on the electrical power fed to the semiconductor light source.

In order to be able to set the power in a desired manner, it is known to alter an electrical voltage for the respective semiconductor light source. However, this method of power control results in some disadvantages, for example a high technical complexity on the part of the control device in order to be able to set the desired voltage, and severe batch-dependent brightness fluctuations of individual semiconductor light sources among one another and/or the like, with the result that this method for the power control of semiconductor light sources has essentially not gained widespread acceptance.

For this reason, a common procedure involves applying electrical power to the semiconductor light sources in clocked operation for the purpose of power setting, such that the semiconductor light sources can be operated in the switched-on state in each case at a predefined, optimum operating point. For this purpose, clock pulse sequences are applied to the semiconductor light sources, wherein the clock pulse sequences are assigned in each case to a corresponding average emitted light power. One method for setting the power is based on pulse width modulation (PWM), for example, wherein a corresponding clock ratio is set according to the desired power to be set. In this case, a clock rate of the clock pulse sequence is chosen in such a way that the intended illumination function is essentially not adversely affected thereby.

However, clocked operation mentioned above can result in problems with regard to a calculation complexity for the clock pulse sequences or the like, particularly if a great multiplicity of clock pulse sequences are required for the setting of a corresponding multiplicity of semiconductor light sources.

### SUMMARY OF THE INVENTION

The illuminant converts the electrical power provided by the electrical energy source, by means of its semiconductor light sources, into an emitted light power dependent on the electrical power provided. For this purpose, the illuminant is connected to the electrical energy source, for example by virtue of the illuminant including electrical terminals which are suitable for this purpose and via which a corresponding connection to the electrical energy source can be produced. The electrical energy source can be for example a public energy supply network, a regenerative energy generating installation, for example a solar installation, a wind power installation, but also a fuel cell, an internal combustion engine generator set, combinations thereof or the like.

Illuminants of the generic type often include a multiplicity of semiconductor light sources connected to the control device. For this purpose, corresponding interconnections can be provided, for example a series connection at least of portions of the semiconductor light sources, a parallel connection, combinations thereof, in particular matrix circuits, and/or the like.

Particularly when illuminants of the generic type are used in the field of vehicle headlights or front headlights in vehicles such as automobiles, a large number of advantages are afforded, such as, for example, the realization of a cornering light without the need for a mechanism, the realization of safety-relevant functions and/or the like. Safety-relevant functions may include, for example, masking out an oncoming vehicle in order to reduce a dazzle effect or highlighting dangerous locations and/or situations by increasing the brightness in such an area. Furthermore, the energy efficiency can also benefit from the use of illuminants of the generic type, particularly if only that partial region of the illuminant is driven or activated which is necessary for the desired generation of a light distribution, in contrast to solutions in which a desired light distribution is generated by trimming by means of diaphragms in the case of a traditional illuminant.

The invention therefore addresses the problem of specifying a control device, a method and also a lighting apparatus and a computer program with which an improvement can be achieved in this regard.

As a solution, the invention proposes a control device having the features of independent claim 1. The invention correspondingly proposes a lighting apparatus as claimed in further independent claim 4. With regard to the method, the invention proposes a method as claimed in independent claim 5. Finally, the invention proposes a computer program product as claimed in independent claim 14. Further advantageous configurations and features are evident on the basis of the dependent claims.

The invention is concerned, in particular, with the effects of the use of semiconductor light sources on the electrical energy supply and electromagnetic compatibility. Semiconductor light sources are light sources consisting of a solid which, on account of its physical properties, generates light when an electric current is applied to it. The use of such semiconductor light sources requires particular measures in order to be able to generate the light in a desired manner and at the same time to be able to achieve reliable operation as intended. At the same time, semiconductor light sources generally have very small time constants, which explains why a change in the electrical power supplied often essentially directly results in a corresponding change in the light power emitted by the semiconductor light source.

With regard to the control device, the invention therefore proposes, in particular, that the control device is implemented for an illuminant including at least two semiconductor light sources and connectable to an electrical energy source, for converting an electrical power provided by the electrical energy source, by means of the semiconductor light sources, into an emitted light power dependent on the electrical power provided, wherein the semiconductor light sources are connected to the control device, and the control device is designed to set the electrical power provided by virtue of the control device including a clock generator designed to apply electrical power to the semiconductor light sources in clocked operation and to control said semiconductor light sources in accordance with clock pulse sequences individually assigned to the semiconductor light sources, wherein the clock generator is designed to form a common pulse pattern from the clock pulse sequences and to set the light power emitted by the illuminant by selecting a pulse pattern assigned to the light power. The control device can be formed as an electronic circuit, a correspondingly programmed computer unit, combinations thereof or the like. It can furthermore be formed by a semiconductor chip.

A particularly simple control can be achieved in this way, particularly if the illuminant includes a large number of semiconductor light sources requiring a likewise large number of clock pulse sequences. By way of example, such pulse patterns can be stored beforehand, such that a very fast setting of the illuminant to the desired light power can be achieved without the need for complex signal processing measures for determining the respective clock pulse sequences. As a result, with regard to the control device, complexity can be reduced and/or a setting speed can be increased.

In accordance with a further aspect of the invention, the effects of the intended operation of semiconductor light sources on the electrical energy supply can be significantly reduced by the provision of clock pulse sequences. An illuminant often includes a plurality of semiconductor light sources. The semiconductor light sources can be interconnected in an electrical series connection, in an electrical parallel connection, in mixed forms thereof, in particular matrix circuits and/or the like. The number of light sources determines the maximum light power of the illuminant formed thereby. In particular, what can be achieved by the interconnection is that a sub-number of semiconductor light sources of the illuminant can be driven in each case jointly by means of a clock pulse sequence.

The semiconductor light sources are connected to the electrical control device and electrical energy is applied to them by said control device in order to be able to implement their intended light generating function in an intended manner. For this purpose, the semiconductor light sources can be connected to the control device individually or else groupwise. In the case of groupwise connection to the control device, the semiconductor light sources of the group can be operated only jointly by means of a clock pulse sequence.

The electrical energy source provides the power required for intended operation of the illuminant, which is preferably the electrical power provided. The power provided accordingly includes, in particular, the electrical power resulting from the application of electrical power to the semiconductor light sources by the control device. Supplementarily, an electrical power of the control device and of further components required may also be included. The provided electrical power of the electrical energy source is preferably the electrical power output to the illuminant and/or the control device in a substantially steady-state operating state of said illuminant and/or of said control device.

The control device includes electronic switching elements for the semiconductor light sources or groups of semiconductor light sources connected to it, which electronic switching elements apply an electrical power or an electric current to said semiconductor light sources as intended. The electronic switching elements are generally embodied as semiconductor switches. However, they can also be embodied as nano-switching elements, combinations thereof or the like. The switching elements can be provided as a separate assembly or else embodied integrally with the control device. By way of example, the switching elements can be provided as an electronic circuit, a semiconductor chip, combinations thereof or the like.

Semiconductor switches within the meaning of this disclosure are preferably controllable electronic switching elements, for example a transistor, in particular a bipolar transistor, a thyristor, combination circuits thereof, for example a metal oxide semiconductor field effect transistor (MOSFET), an isolated gate bipolar transistor (IGBT) or the like.

Switching operation of the semiconductor switch means that, in a switched-on state, a very low electrical resistance is provided between the terminals of the semiconductor switch that form the switching path, with the result that a high current flow in conjunction with very low residual voltage is possible. In the switched-off state, the switching path of the semiconductor switch is at high resistance, that is to say that it provides a high electrical resistance, such that even at high voltage present across the switching path, substantially no or only a very low, in particular negligible, current flow is present. Linear operation differs from this, but is not used in electronic switching elements.

Preferably, the number of switching elements switched on by means of the control device determines the power provided by the electrical energy source. Furthermore, provision can be made for the control device to control the electrical energy source with regard to the provision of power. Control can also be provided for a clocked electronic energy converter used to convert the electrical power provided by the electrical energy source into an electrical power suitable for the control device.

Of course, provision can also be made for all of the semiconductor light sources to be connected to the control device in each case by themselves and individually. In this way, each semiconductor light source can be driven individually by the control device in a desired manner. In particular, provision can also be made here for groups of semiconductor light sources to be formed which are controlled by the control device with a common clock pulse sequence. This has the advantage that the group formation can be defined by the control device itself and if appropriate can be adapted as necessary by individual or a plurality of semiconductor light sources being added to the group or removed from the group.

Even though the invention hereinafter will be explained in further detail on the basis of vehicle headlights as a lighting apparatus, the embodiments are however not restricted to vehicle headlights and can of course also be used in any other lighting apparatuses or illuminants.

The invention makes it possible to achieve a dynamically changing light distribution of the illuminant, which can be achieved by corresponding driving of the semiconductor light sources of the illuminant. With the changing light distribution of the illuminant there is also a change in the distribution of the electrical power over the illuminant, that is to say the local power density, specifically over the semiconductor light sources which the illuminant includes.

In the case of a vehicle headlight, a current demand on average over time of approximately 13 to 16 A may be established for example in the case of a typical light distribution, wherein such a vehicle headlight, in the case of maximum light generation, may require an electric current in a range of 33 to 38 A, for example. The difference between the two abovementioned values of the electric current is provided as a reserve that can be kept available for illumination during cornering, for example. As a result, it is possible also to expediently illuminate a pivoting range during cornering with such a vehicle headlight and thus to improve driving safety overall.

It follows from this that, of course, the current distribution or the power distribution over the semiconductor light sources forming the illuminant also changes dynamically depending on a driving situation.

Semiconductor light sources have the property that their light generation is essentially directly dependent on the electrical power supplied or the electric current supplied. Accordingly, time constants in the event of a change in an illumination state of the illuminant are very small.

An illuminant of the generic type for a vehicle headlight can include for example 3000 or more semiconductor light sources that can be driven by the control device preferably individually by means of a, preferably individual, clock pulse sequence in the form of a pulse width modulation (PWM). The individual semiconductor light sources are supplied with energy in parallel by the electrical energy source to which the illuminant is connected.

On account of the multiplicity of semiconductor light sources and the required dynamic characteristic and efficiency of the system formed thereby, particular requirements are thus made of an electrical circuit of the control device that can be used to realize the required or desired operating states of the illuminant. Therefore, one essential aspect of the invention is to bring about an improvement here, such that requirements made of the electronic circuit can be significantly reduced, without restricting the possibilities of the illuminant, for example in an application as a vehicle headlight. Even though this inventive aspect is particularly pronounced for a large number of semiconductor light sources, the advantageous effects are of course also demonstrable for a small number of semiconductor light sources—for example two or a plurality.

For this purpose, the control device may include for example a controllable, electronic clocked energy converter, for example a buck converter, a boost converter or the like, which the electronic circuit preferably includes. The electronic clocked energy converter draws the electrical power preferably directly from the electrical energy source.

Furthermore, it should be taken into consideration that the complexity of the driving of such a vehicle headlight and also of corresponding illuminants in general, and of the associated signal processing power to be kept available requires new approaches which can regulate in particular the clocked electronic energy converter anticipatorily.

One aspect of the invention is the temporal shift of clock pulse sequences for the individual semiconductor light sources relative to one another, with the aim of being able to reduce sudden load changes or sudden power changes, particularly at the beginning of a respective clock cycle. However, the invention should not be considered to be restricted only to this, but rather serves in general also to detect operating states of the generation of light power by means of the illuminant, specifically in particular transitions from one light generating state to another light generating state. This last can be achieved according to the invention, for example, by virtue of the fact that the clock pulse sequences for the semiconductor light sources for a specific illumination state of the illuminant are combined to form pulse patterns and, upon transition from one light generating state to another light generating state of the illuminant, pulse patterns are interposed which alleviate an abrupt change in the electrical power supplied.

What can furthermore be achieved by means of the invention is that requirements made of the electronic clocked energy converter can be significantly reduced. In particular, requirements made of power electronics of a buck converter can be reduced. Furthermore, by means of an interpolation of state transitions by means of interposed pulse patterns or an adaptation of sudden load changes or sudden power changes to the dynamic characteristic actually required during cornering, for example, the dynamic characteristic of the power consumption of the illuminant or of the current consumption of the illuminant can decrease. Furthermore, by shifting PWM cycles or clock pulse sequences of the individual semiconductor light sources with respect to one another, it is possible to achieve a reduction of the maximum summation current to be provided or of the maximum summation power to be provided over the entire semiconductor light source structure of the illuminant.

It proves to be particularly advantageous if both aspects mentioned above are combined with one another, as a result of which the requirements made of the electrical energy source and the electronic clocked energy converter can be significantly reduced. Firstly, it is possible to avoid a situation where the electronic clocked energy converter has to map the complete dynamic characteristic of the illuminant and the power reserve to be kept available has to be designed accordingly. As a result, the complexity with regard to the electronic clocked energy converter can be reduced, thus resulting in lower costs. Furthermore, perturbing reactions affecting the electrical energy source, in particular an energy supply network, can be reduced. This proves to be particularly advantageous in the case of island power supply systems, for example an on-board power supply system of a vehicle or the like. By way of example, the complexity for a filtering can be reduced.

The invention furthermore proposes that the control device includes an electronic clocked energy converter controllable by means of the control device. What can be achieved by the possibility of controlling the electronic clocked energy converter by means of the control device is that said converter is controlled adaptively, in particular proactively, such that it is possible to react better to state changes, in particular light generating state changes, of the illuminant. As a result, it is possible to reduce complexity in the area of the electronic clocked energy converter, for example in the area of the filtering and/or the like.

The semiconductor light source may preferably include a light emitting diode or a laser diode. Such light emitting diodes or laser diodes can also be assembled together in combination with one another modularly. In particular, they can be embodied on a common chip or the like. Light emitting diodes or laser diodes or combinations thereof are suitable in particular for use as semiconductor light source in the invention.

In terms of the lighting apparatus, the invention thus proposes, in particular, that the lighting apparatus includes a plurality of semiconductor light sources, an electrical terminal for connecting the lighting apparatus to an electrical energy source, and a control device, to which the semiconductor light sources are connected. The control device is embodied according to the invention. The lighting apparatus can be formed for example by a vehicle headlight, a vehicle rear light, but also a lamp for room lighting or the like. The lighting apparatus itself can be designed for example to releasably receive the illuminant and to make electrical contact with it. By way of example, the illuminant can be embodied as an exchangeable unit or exchangeable module. In particular, the illuminant can have a connection mount by which it can be simultaneously both mechanically and electrically connected to the lighting apparatus. In this way, it is possible to exchange a detective illuminant of the lighting apparatus for an intact illuminant. Furthermore, this configuration allows the invention also to be retrofitted in existing lighting apparatuses.

In terms of the control device, the invention therefore proposes, in particular, that the control device is suitable for an illuminant including at least two semiconductor light sources and connectable to an electrical energy source, for converting an electrical power provided by the electrical energy source, by means of the semiconductor light sources, into an emitted light power dependent on the electrical power provided, wherein the semiconductor light sources are connected to the control device, and the control device is designed to set the electrical power provided by virtue of the control device including a clock generator designed to apply electrical power to the semiconductor light sources in clocked operation, wherein the clock generator is designed to control the semiconductor light sources in accordance with clock pulse sequences individually assigned to the semiconductor light sources in such a way that clock pulses of a first clock pulse sequence are temporally shifted with respect to clock pulses of a second clock pulse sequence. The control device can be formed as an electronic circuit, a correspondingly programmed computer unit, combinations thereof or the like. It can furthermore be formed by a semiconductor chip.

Preferably, the clock pulse sequences are assigned in each case to a single semiconductor light source. However, provision can also be made for the clock pulse sequences to be assigned to two or a plurality of semiconductor light sources. This configuration is expedient particularly if semiconductor light sources are intended to be controlled in a manner combined into groups.

Of course, the invention is not restricted to application in the case of two semiconductor light sources, but rather can be expediently used in particular, of course, in the case of illuminants having a multiplicity of semiconductor light sources. The advantages according to the invention can be manifested particularly clearly particularly in the case of a very large number of semiconductor light sources of the illuminant. In principle, a dedicated individual clock pulse sequence can be provided for each semiconductor light source. In this case, each semiconductor light source is directly connected to the control device, such that the latter can apply to it the clock pulse sequence assigned to the semiconductor light source. Provision can also be made, of course, for a predefined number of semiconductor light sources to be jointly electrically interconnected and to be jointly connected to a terminal of the control device. In this case, the semiconductor light sources jointly connected to the control device are jointly controllable with a common clock pulse sequence specific to this group. The common interconnection forms a fixedly set hardware group which is always controlled jointly with a single clock pulse sequence. Furthermore, of course, optionally the control device can also apply the same clock pulse sequence to individual semiconductor light sources connected individually to the control device. Particular light effects can be obtained as a result. In particular, mixed operation can be provided in which individual clock pulse sequences are applied to some of the semiconductor light sources and a common clock pulse sequence is applied to others.

The temporal offset of the clock pulse sequences can be chosen in such a way that clock pulses of different clock pulse sequences overlap or else do not overlap. Furthermore, provision can be made for a clock pulse sequence to have temporally variable clock pulses that differ from one another both with regard to their time duration and with regard to their temporal distance from adjacent clock pulses. By way of example, it can be provided that one clock pulse sequence can be shifted relative to another clock pulse sequence over a variably adjustable time. Preferably, more than two clock pulse sequences are present which are correspondingly temporally offset relative to one another. However, it can also be provided that, in the case of more than two clock pulse sequences, only two of the clock pulse sequences are temporally offset relative to one another. Further combinations can also be provided in this regard.

One advantage of the technical features described is that a reduction of requirements made of the controllable electronic clocked energy converter can be achieved. As a result of the interpolation of image transitions or pulse patterns by means of intermediate values or adaptation of sudden load changes to a dynamic characteristic actually required, it is possible to reduce the dynamic characteristic of the current loading or power loading. The shift of PWM cycles of the individual semiconductor light sources with respect to one another results in a reduction of the maximum summation current to be provided over the entire semiconductor light source structure of the illuminant.

Both measures enable a more efficient design of the controllable electronic clocked energy converter because said converter need not map the complete dynamic characteristic of the system formed by the illuminant and a power reserve can be reduced. As a result, the complexity of the controllable electronic clocked energy converter can be reduced, as a result of which costs can be saved.

Furthermore, perturbing effects on an energy supply network or the electrical energy source can be reduced. In particular, filter complexity can be reduced.

Correspondingly, in terms of the method, the invention proposes, in particular, a method for controlling an illuminant including at least two semiconductor light sources and connected to an electrical energy source, wherein
the illuminant converts an electrical power provided by the electrical energy source, by means of the semiconductor light sources, into an emitted light power dependent on the electrical power provided,
the electrical power provided is set by means of a control device by virtue of electrical power being applied to the semiconductor light sources in clocked operation by means of the control device,
the semiconductor light sources are controlled in accordance with clock pulse sequences individually assigned to the semiconductor light sources, wherein,
the clock pulse sequences form a common pulse pattern and the light power emitted by the illuminant is set by the selection of a pulse pattern assigned to the light power.

The advantages and embodiments mentioned with respect to the control device apply equally to the method according to the invention.

In accordance with one development, it is proposed that switching over from a first pulse pattern assigned to a first emitted light power to a second pulse pattern assigned to a second emitted light power is carried out for the purpose of changing the light power emitted by the illuminant. As a result, it is possible, in a particularly simple manner, to change the emitted light power of the illuminant in a desired manner. By way of example, prestored pulse patterns can be used, such that a signal processing complexity, in particular computer complexity, can be reduced. It proves to be particularly advantageous, however, if use is made of an algorithm for determining suitable pulse patterns, in order to determine pulse patterns in a manner dependent on the desired light distribution. On the basis of the algorithm, it is possible to create a computer program which allows the computer unit of the clock generator to be able to determine a multiplicity of different pulse patterns without great expenditure of time. It can likewise be provided that a field programmable gate array (FPGA) is programmed in accordance with such an algorithm and, in the case of use in the clock generator, determines and provides the pulse patterns corresponding to the desired light distribution.

Furthermore, the invention proposes that switching over from the first to the second pulse pattern includes interposing at least one third pulse pattern assigned to a light power between the first light power and the second light power. As a result, it is possible to influence switching processes between the first pulse pattern and the second pulse pattern to the effect that large current and/or light fluctuations can be reduced. Furthermore, it is thereby possible to achieve a soft, ergonomically visually expedient switching or changing of the light power. Finally, requirements made of the electrical energy source, in particular also of the clocked electronic energy converter, can be reduced.

In accordance with a further aspect of the invention, it proves to be particularly advantageous if the clock pulses of a first clock pulse sequence lie in clock pauses of a second clock pulse sequence. In this case, it is possible to achieve a particularly expedient loading on the electrical side of the illuminant because peak powers or peak currents can be reduced. This also proves to be particularly advantageous if the semiconductor light sources have substantially identical physical properties. However, even with deviating physical properties, advantageous aspects can be implemented with the invention. What can furthermore be achieved with this aspect is that power supply system perturbations, for example harmonics on the electrical side, can be reduced.

In accordance with a further aspect of the invention, it is proposed that in each case a clock pulse of the second clock pulse sequence is temporally directly adjacent to a, preferably each, clock pulse of the first clock pulse sequence. As a result, it is possible to achieve a further improvement on the electrical side of the illuminant because, firstly, a power loading or current loading can be reduced further and, at the same time, it is also possible to achieve the effect that high-frequency currents can be reduced.

In accordance with a further configuration of the invention, it is proposed that the clock pulses of the first clock pulse sequence last for a time duration that deviates from the clock pulses of the second clock pulse sequence. This allows the semiconductor light sources to which the respective clock pulse sequence is applied to be operated with a different power, such that the corresponding semiconductor light sources generate a different light power.

The term power in the sense of this application means an average power determined by means of an averaging over time, the time period of which is significantly greater than the time period of a clock period of the respective clock pulse sequence, for example for 5, 10 or even more clock periods of the clock pulse sequence.

The power defined in this sense is applicable both on the electrical side and on the light engineering side. Preferably, the time period of the averaging is dimensioned in such a way that the light emission—brought about by a clock pulse sequence—of the corresponding semiconductor light source generates a continuous visual effect in a present substantially steady-state light generating state at the human eye, if the clock pulse sequence is a steady-state clock pulse sequence which is assigned to a corresponding power and thereby defines a corresponding operating state.

It proves to be particularly advantageous that with the invention the electrical power provided by the electrical energy source is converted by means of an electronic clocked energy converter, wherein the electronic clocked energy converter is controlled proactively by means of the control device. As a result, complexity with regard to the electronic clocked energy converter can be reduced further because the converter can be correspondingly adapted to the imminent change in energy provision. As a result, not only is it possible to reduce complexity with regard to the energy converter and, if appropriate, filtering, but it is also possible to achieve a more expedient transition with regard to the power change of the illuminant. Proactively means that the electronic clocked energy converter is adaptively adapted to the imminent loading before the occurrence of a change in loading, in particular a power change.

In one development, it is provided that the proactive control includes communicating a suitable control signal to the electronic clocked energy converter before a clock pulse sequence and/or a pulse pattern are/is activated by means of the control device. As a result, the electronic clocked energy converter can be adapted to the change even better.

Finally, the invention proposes, in particular, a computer program product including a program for a computer unit of a clock generator of a control device, wherein the program includes program code sections of a program for executing the steps of the method according to the invention if the program is executed by the computer unit. Preferably, the program code sections are created on the basis of an algorithm. The algorithm provides for example a specification according to which the computer unit determines and provides clock pulse sequences, pulse patterns and/or the like by means of the program that realizes the algorithm.

The abovementioned computer program product can be embodied as a computer-readable storage medium. Furthermore, the program can be loadable directly into an internal memory of the computer unit. In this regard, it is possible, for example, to download the program from a network from a data source, for example a server, and to load it into an internal memory of the computer unit, such that the computer can execute the program.

Preferably, the computer program product includes a computer-readable medium on which program code sections are stored. Such a computer-readable medium may be for example a memory component, a compact disk, a USB stick, or the like.

### BRIEF DESCRIPTION OF THE DRAWINGS

Further advantages and features can be gathered from the following description of exemplary embodiments with reference to the figures. The exemplary embodiments serve merely for explaining the invention and are not intended to restrict the latter. In the figures, identical component parts and functions are designated by identical reference signs.

In the figures:

FIG. 1 shows, in a schematic view, a vehicle headlight as a lighting apparatus having a light emitting diode matrix as illuminant, wherein the light emitting diodes as semiconductor light sources are interconnected to form matrices in a first operating state,

FIG. 2 shows the vehicle headlight in accordance with FIG. 1 in a second operating state,

FIG. 3 shows a basic circuit diagram for a control device according to the invention,

FIG. 4 shows a schematic illustration of a percentage proportion of a respective gray level in a basic light distribution of the headlight in accordance with FIG. 1,

FIG. 5 shows a schematic illustration of a time profile of an electric current for an illuminant in an upper diagram and a diagram with corresponding clock pulse sequences for the respective light emitting diodes in a lower illustration,

FIG. 6 shows an illustration like FIG. 5, wherein the clock pulse sequences are chosen according to the invention,

FIG. 7 schematically shows two diagrams arranged one above the other, wherein an upper diagram shows a current consumption of the illuminant over time for different pulse patterns and the lower illustration shows a diagram regarding a change in the phase angle of PWM channels for the individual light emitting diodes,

FIG. 8 shows two diagrams arranged one above the other, wherein an upper diagram illustrates the current consumed by the illuminant over time and the lower diagram illustrates corresponding control signals for light emitting diodes of the illuminant over time,

FIG. 9 shows two diagrams arranged one above the other like FIG. 8, wherein the upper diagram illustrates a current profile for interposed pulse patterns and the lower diagram schematically illustrates correspondingly assigned control signals for the light emitting diodes of the illuminant,

FIG. 10 shows a schematic block diagram for an electronic circuit of a register arrangement for driving eight light emitting diodes,

FIG. 11 shows a logic table based on a register driving in accordance with FIG. 7 for control signals for the eight light emitting diodes which are generated by the register set in accordance with FIG. 10,

FIG. 12 shows an illustration like FIG. 11, wherein the PWM channels for the light emitting diodes are offset according to the invention,

FIG. 13 shows a schematic illustration of pulse patterns for switching on the illuminant,

FIG. 14 shows a switch-on process like FIG. 13, but with interposition of pulse patterns according to the invention,

FIG. 15 schematically shows a conventional driving like FIG. 13, and

FIG. 16 shows a schematic illustration of a further configuration of the invention, in which a plurality of pulse patterns are interposed when the illuminant is switched on, in order to realize a dimming function.

### PREFERRED EMBODIMENT OF THE INVENTION

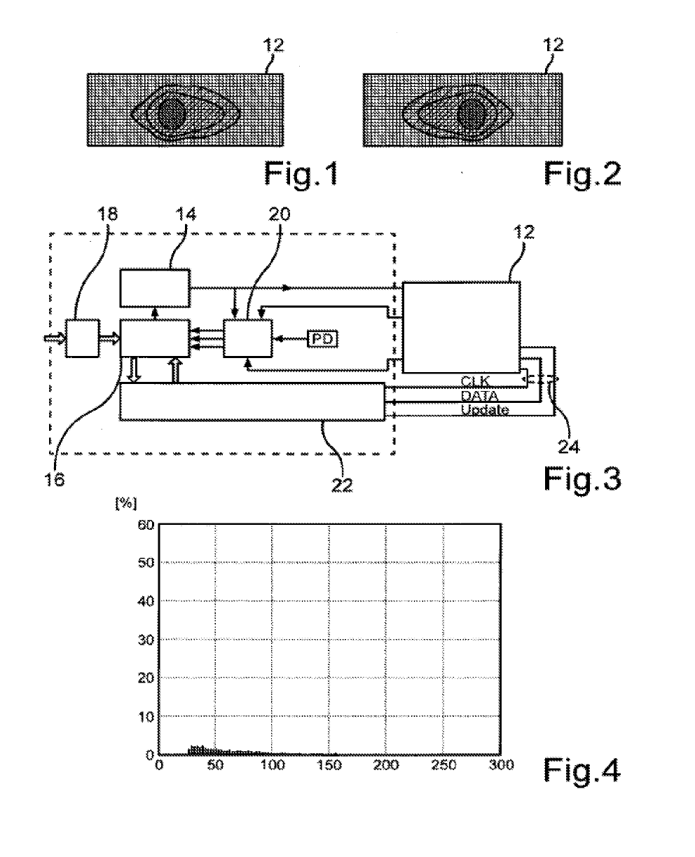

FIG. 1 illustrates in a schematic view a plan view of an illuminant 12 having a multiplicity of light emitting diodes interconnected to form matrices, which illuminant is provided for installation in a vehicle headlight of a vehicle. FIG. 1 shows a first light distribution of the vehicle headlight in a first operating state. FIG. 2 illustrates the same headlight, but now in a second operating state, in which a changed luminous pattern compared with FIG. 1 is activated. The illuminant 12 has a planar support (not illustrated), which provides a surface on which the multiplicity of light emitting diodes are arranged alongside one another in a gridlike fashion. The light emitting diodes are individually connected to a control device 10 (FIG. 3) individually.

It is thereby possible to drive each light emitting diode of the illuminant 12 individually in order to achieve desired lighting effects in line with requirements.

As a result of a dynamically changing light distribution of the illuminant 12, a load distribution over the structure of the illuminant 12 also changes. On account of the application as a vehicle headlight, in the present case a current demand on average over time of approximately 13 to 18 A results for a typical light distribution such as is illustrated in FIGS. 1 and 2. A current consumption in a range of 33 to 46 A is provided at maximum light power. The difference between the two values corresponds to the reserve that is intended to be kept available for example for lighting during cornering. It is evident from this that the current distribution or power distribution over the illuminant 12 also changes dynamically depending on the driving situation.

The possibilities of this vehicle headlight are also used for safety-relevant functions, for example a spotlight for marking sources of danger.

On account of the use of light emitting diodes as semiconductor light sources, the time constants for a change in the current distribution in the illuminant 12 are small. In the present case, the light emitting diodes have substantially identical physical properties.

In the present case, it is provided that the illuminant 12 includes a multiplicity of light emitting diodes, specifically 3000 light emitting diodes. In alternative exemplary embodiments, it is also possible, of course, to provide more than 3000 light emitting diodes for an illuminant 12. The light emitting diodes of the illuminant 12 are connected in parallel and individually drivable by PWM as clock pulse sequence on the part of the control device 10. As will be explained in even further detail below, the control device 10 includes for this purpose an electronic clocked energy converter, which is embodied as a buck converter 14 in the present case.

FIG. 3 shows, in a schematic illustration, a block diagram of the control device 10. The control device 10 is connected to the illuminant 12, such that all the light emitting diodes of the illuminant 12 can be individually controlled by the control device 10. The control device 10 furthermore includes the buck converter 14, which provides the electrical power for operating the light emitting diodes of the illuminant 12. Finally, the control device 10 includes a computer unit 16 connected to an interface circuit 18, via which connection to an external communication network is possible.

Furthermore, the computer unit 16 is connected to the buck converter 14 and supplies control signals for the operation thereof. Finally, the computer unit is connected to an analog signal processing unit 20, which processes signals of the illuminant 12 and also of the buck converter 14 and supplies corresponding signals to the computer unit 16. Furthermore, the computer unit 16 is connected to a clock generator 22, which, in accordance with a predefinition of the computer unit 16, generates clock signal sequences in the sense of the invention and outputs them to the illuminant 12 for the purpose of controlling the light emitting diodes of the illuminant 12. Furthermore, the clock generator 22 can supply signals to the computer unit 16, for example about present operating states, clock pulse patterns presently assigned to the light emitting diodes, and/or the like. FIG. 3 does not illustrate the fact that the buck converter 14 is connected to an electrical on-board power supply system of a motor vehicle, from which it draws the electrical energy for operating the control device 10 and the illuminant 12.

In the present case, it is provided that a defined current or a defined power can be applied to each light emitting diode individually. For this purpose, the clock generator 22 has corresponding switching elements (not illustrated). The control of an average brightness of the respective light emitting diodes of the illuminant 12 is realized by means of a clock pulse sequence based on PWM. On account of the multiplicity of light emitting diodes, here 3000, the driving of the light emitting diodes by means of switching elements is not effected directly, but rather via a serial interface 24. The corresponding switching elements are instead arranged in the illuminant 12 itself. The clock generator 22 therefore has the task, inter alia, of performing signal preprocessing within the system. Said signal preprocessing includes the fact that a light distribution of the illuminant 12 is created and converted into a suitable PWM driving coordinated with the respective specific individual light emitting diode of the illuminant 12. The clock generator 22 obtains corresponding parameters on the computer unit 16. The computer unit 16 furthermore has the function within the system of controlling the buck converter 14, evaluating analog signals and feeding them to the clock generator 22 for further processing.

The computer unit 16 can be embodied as a unit operating in parallel with a high processing speed. In the present case, it is formed by a semiconductor chip that is part of an electronic circuit of the control device 10.

Within the system described above, the combination of a multiplicity of clocked light emitting diodes represents a particular challenge for the design of the buck converter 14. This is clarified on the basis of an illustration in accordance with FIG. 4 for the illuminant 12 as a vehicle headlight. In this configuration, it is provided that approximately 45% of the available light emitting diodes of the illuminant 12 are switched within a cycle time of at most 5 ms (200 Hz). A brightness change of the basic light distribution illustrated in FIG. 4 is achieved by PWM in the present case. The non-activated 55% of the available light emitting diodes are thus available to implement further lighting functions, for example safety functions, pivoting functions or the like, to be precise without the need for mechanical movements to be realized.

If an operating current of 10 milliamperes is set for an individual light emitting diode and in each case 1000 light emitting diodes are jointly supplied with electrical energy by a buck converter 14, with a capacity utilization of 45% this leads to a pulsed current of 4.5 A. This current has to be provided in the 5 ms rhythm, for which reason this boundary condition should be taken into account as an essential condition for the design of the buck converter 14. By contrast, if the current used on average over time within the stated 5 ms is considered, a value of approximately 1.33 A would result. This value is significantly lower, for which reason, for realization of such a value, the buck converter 14 could be significantly reduced with regard to its hardware design.

One feature of the invention is that it is possible to realize a temporal shift of the PWM cycles, that is to say of the clock pulse sequences, for the individual light emitting diodes among one another, such that sudden load changes at the beginning of a cycle can be significantly reduced. Furthermore, the possibility is afforded of fashioning transitions between two light states of the illuminant 12 by means of intermediate images or corresponding pulse patterns and interpolation that can be realized thereby in such a way that a temporal dynamic characteristic of a current change can be significantly reduced. Furthermore, this results in a system architecture which can also enable an anticipatory, that is to say proactive, control of the buck converter 14.

The invention takes up this insight for driving the light emitting diodes asynchronously, that is to say for controlling them with individually assigned clock pulse sequences, such that clock pulses of the first clock pulse sequence are temporally shifted with respect to clock pulses of a second clock pulse sequence. Preferably, this applies to a plurality, in particular all, of the clock pulse sequences that serve for controlling the light emitting diodes of the illuminant 12. Of course, it is also possible for a plurality of light emitting diodes of the illuminant 12 to be operated simultaneously with one clock pulse sequence, in order to limit the number of different clock pulse sequences.

Overall, one aspect of the invention is to be able to achieve a current consumption that is constant over time to the greatest possible extent. By way of example, this means that, in the case of four light emitting diodes having a predefined average brightness of 25%, said light emitting diodes are not switched or clocked synchronously, but rather successively with a temporal offset. This reduces the current amplitude for such a circuit to ¼ of the summation current that would be obtained in the case of simultaneous activation of the light emitting diodes. Peak currents and amplitudes of sudden changes in current can thus be reduced, as a result of which the transient requirements made of the buck converter 14 also decrease. This leads to a significant reduction of costs and structural size, since, for example, simpler coils having a lower inductance can be used. Furthermore, the efficiency of the buck converter 14 can be improved.

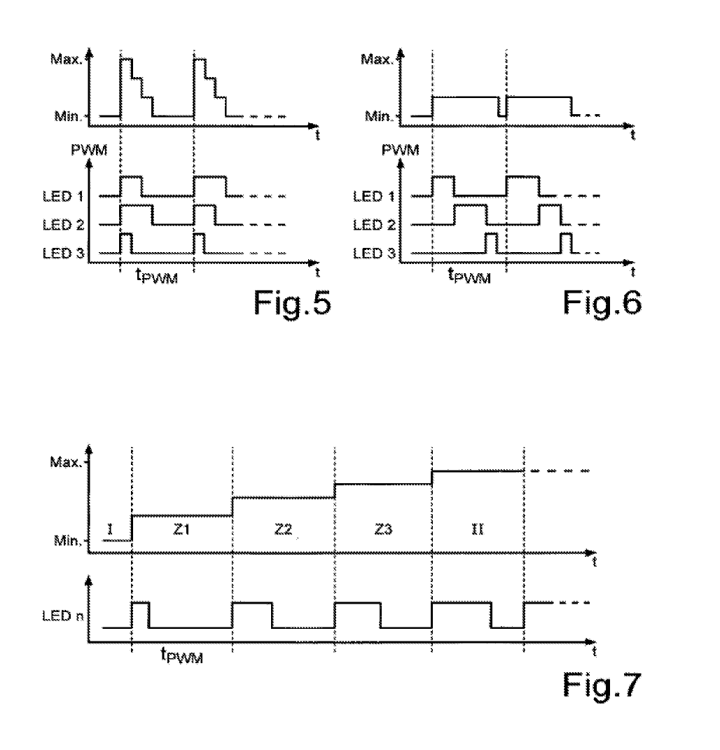

FIG. 5 shows by way of example two timing diagrams arranged one above the other, which schematically illustrate a current profile over time for a summation current of three light emitting diodes that are correspondingly controlled in accordance with the lower diagram. It can be discerned that a current of three times the magnitude of the current of an individual light emitting diode is established in a short time interval at the beginning of the time interval t_{PWM}. FIG. 6 shows an illustration like FIG. 5, but in contrast to FIG. 5 the operating times of the three light emitting diodes are correspondingly offset, such that they do not overlap. The current profile illustrated in the upper diagram in FIG. 6 arises as a result, said current profile necessitating merely a current requirement of the magnitude of the current of a light emitting diode.

In the case, too, of the method according to the invention as illustrated in FIG. 7, the motivation is to reduce the requirements made of the buck converter 14 by avoiding large sudden changes in current.

FIG. 7 shows two diagrams arranged one above the other, wherein the change from an operating state I to an operating state II of the illuminant 12 is intended to be achieved. The upper diagram in FIG. 7 illustrates the current consumption of the illuminant 12, whereas the lower diagram in FIG. 7 illustrates the corresponding control signals for the light emitting diodes. Proceeding from the operating state I, firstly an intermediate image Z1 is generated by means of a first control signal, said intermediate image resulting in a current consumption of the illuminant 12 that is greater than that of the operating state I, but less than that of the operating state II. In a next PWM cycle, a second intermediate image Z2 is activated, which results in a current consumption of the illuminant 12 that is greater than that of the intermediate image Z1, but less than that of the operating state II. An intermediate image Z3 is generated in a subsequent cycle, said intermediate image resulting in a current consumption of the illuminant 12 that is greater than that of the intermediate image Z2, but less than that of the operating state II. The operating state II is attained only in a subsequent cycle. This measure makes it possible to avoid a steep and large current rise and the loadings associated therewith. In the present case, the cycle time is approximately 5 ms.

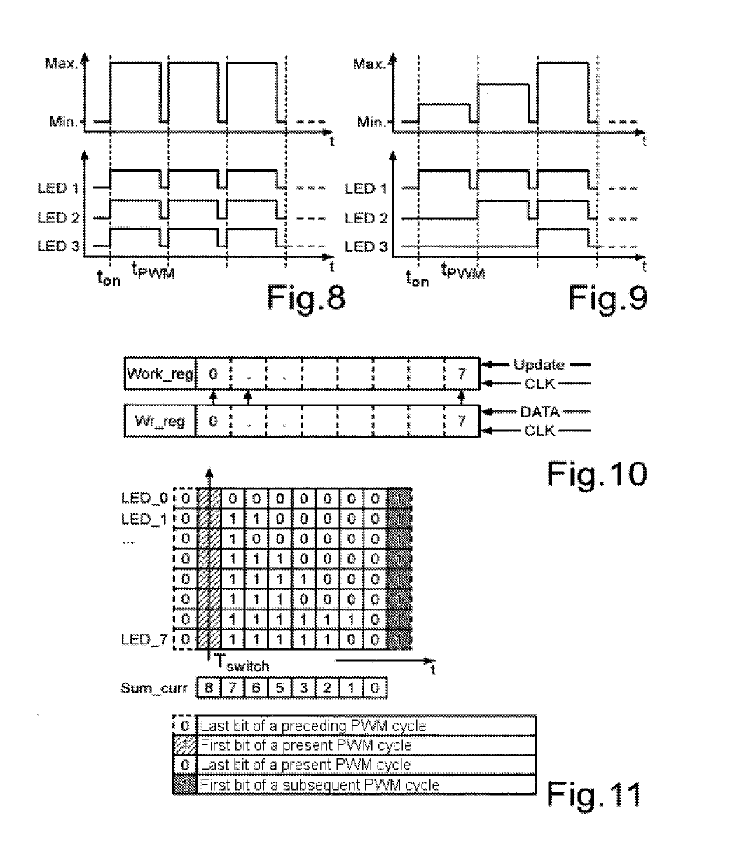

This configuration is suitable for example for the case where the vehicle headlight is used in the context of a headlight flashing function. This makes use of the relationship that exists between a PWM cycle and a temporal requirement within the application as a vehicle headlight. With an exemplary cycle time of 5 ms and a time period of 50 ms. For attaining the new operating state there is accordingly the possibility of using intermediate images or pulse patterns for the transition from one operating state to the other operating state, in order thus to reduce an amplitude of sudden current changes. It is evident from this that, in the case of a significant change in the operating state, a step-by-step approximation by intermediate states in the form of pulse patterns is realized. This procedure can also be used for switching on the vehicle headlight, as shown in FIG. 8.

FIG. 8 shows two diagrams arranged one above the other, which illustrate the switching on of the vehicle headlight over time. The upper diagram illustrates over time the respective present current of the illuminant 12 when the light emitting diodes are correspondingly controlled in accordance with the lower diagram. It can be discerned that in this case a large sudden change in current takes place upon switching on at the instant tₒₙ.

FIG. 9 then shows two diagrams like FIG. 8, wherein here as well a switch-on state is again illustrated, but wherein the latter is configured according to the invention It can be discerned that, unlike in the embodiment in accordance with FIG. 8, the light emitting diodes LED1 to LED3 are not switched on simultaneously at the instant tₒₙ, but rather only the light emitting diode LED1. It is only in a subsequent cycle that then additionally the light emitting diode LED2 is switched on and the light emitting diode LED3 in a cycle after that. A correspondingly staircase-like rise of the current profile can be discerned in the upper diagram in FIG. 9. The large sudden changes in current such as arise upon switching on in accordance with FIG. 8 are avoided as a result. A further configuration of the invention results from the fact that pulse patterns for realizing intermediate images are interpolated nonlinearly in order for example to accord with the nature of the human eye and to be able to provide an ergonomically expedient visual impression.

Owing to the presence of the information regarding which operating state of the illuminant 12 is intended to be assumed and, if appropriate, which intermediate images are provided for attaining said operating state, there is the possibility of preparing the buck converter 14 for the corresponding change in load.

If the average current consumption of the illuminant 12 increases, for example, as a result of the change in the operating state of the illuminant 12, then there is the possibility of correspondingly adapting the output voltage and also the converter frequency anticipatorily or proactively. What can be achieved as a result is that upon arrival of the change in load at the buck converter 14 a dip in the output voltage, for example, can be significantly reduced. As a result, a reduced residual ripple of the current of a respective light emitting diode of the illuminant 12 can also be achieved because there is a relationship between the electrical voltage present at the light emitting diode and the electric current flowing through said light emitting diode. Furthermore, there is the possibility of operating the buck converter 14 better with regard to its efficiency by adapting control parameters.

For technical implementation, for example it is possible to use a register set for driving the light emitting diodes of the illuminant 12 such as is illustrated schematically for the driving of eight light emitting diodes by way of example with reference to FIG. 10 and such as is comprised by the control device 10 in the present case. FIG. 10 shows a two-part register set in a schematic view. The register set in accordance with FIG. 10 includes a write register Wr_reg, to which data are written serially. In this case, each bit of this register represents the operating state of a single light emitting diode. For this purpose, the write register Wr_reg has an input terminal DATA and a clock input CLK. Data are written to the write register serially in a known manner.

The register set in accordance with FIG. 10 furthermore includes a work register Work_reg connected to the write register, said work register being connected to the write register Wr_reg. The data written to a write register are transferred into corresponding memory cells of the work register Work_reg, specifically by a corresponding acceptance signal being present at a corresponding control input. Said signal is identified by Update in FIG. 10. The corresponding switching elements for energizing the corresponding light emitting diodes are connected to the work register Work_reg. If the register content of the work register Work_reg contains a logic 1, current is applied to the correspondingly assigned light emitting diode, such that the latter generates light. By contrast, if there is a logic 0 in a corresponding register cell, the correspondingly assigned light emitting diode is not energized. As a result of the change of the values stored in the memory cells of the work register Work_reg by means of the write register Wr_reg in combination with the update signal, an individual clock pulse sequence, here PWM, can be mapped for each light emitting diode. The work register Work_reg also has a clock input CLK, which can preferably be driven by the same clock signal as the write register Wr_reg.

FIG. 11 then shows a tabular illustration of switching states of eight light emitting diodes such as can be driven by the register set in accordance with FIG. 10. The upper square block shows column by column the logic values contained at the respective instants in the work register Work_reg for the respective light emitting diodes in accordance with one exemplary embodiment. Of course, the values illustrated in the block can be correspondingly adapted as necessary for the desired generation of a light power of the illuminant 12. A row illustrating the logically normalized current sum is illustrated below the topmost block diagram. A legend for the different symbols in the topmost block is illustrated below said row. As is evident from FIG. 11, one instant is marked by a vertical arrow. At this instant, all eight light emitting diodes are switched on simultaneously. In the subsequent instants, the number of active light emitting diodes decreases step by step, thus resulting in the normalized current loading illustrated underneath.

These substantive facts have the effect that a large switch-on current arises, such as has already also been explained above with reference to FIGS. 5 and 6.

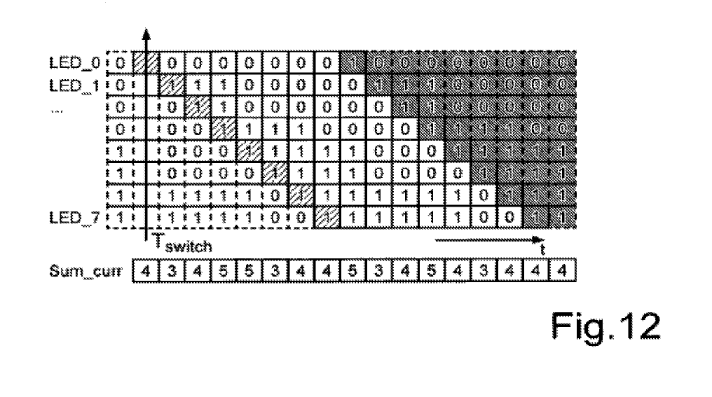

FIG. 12 then shows an arrangement like FIG. 11, but in this arrangement the clock pulse sequences provided for the light emitting diodes are temporally shifted relative to one another. It can be discerned from FIG. 12 that, in the case of the shift illustrated therein, the normalized current sum in each clock cycle is between the values 3 and 5. A balancing of the current consumption of the illuminant 12 can thus be achieved as a result of this asynchronism of the clock pulse sequences for the light emitting diodes. It is evident from the current sum row illustrated below the block in FIG. 12 that the current sum values 0 to 2 and 6 to 8 do not occur. This is advantageous for the current loading of the rest of the circuit, in particular of the control device 10.

The clock pulse sequences are shifted relative to one another by a logic within the clock generator 22.

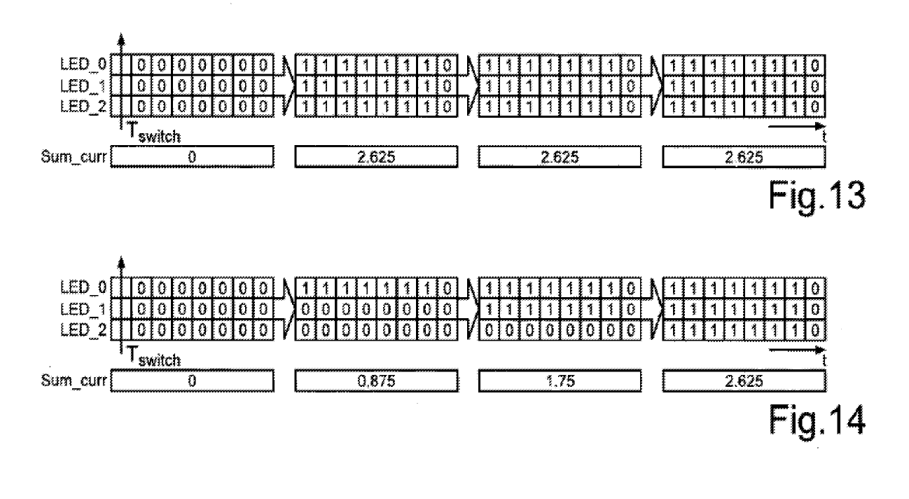

FIGS. 13 and 14 show switching on of the illuminant 12 in a comparison. FIG. 13 shows a switch-on process for three light emitting diodes of the illuminant 12 which are switched on jointly in a conventional manner, specifically from a power 0 to a power of 87.5%. For illustration purposes, four temporally successive blocks with logic switching values such as have already been explained with reference to FIGS. 11 and 12 are illustrated. In the present case, only three light emitting diodes are provided, which are correspondingly switched. In principle, however, this is applicable to an arbitrary number of light emitting diodes.

Here as well a power control by means of PWM is provided again. This is evident from the four blocks illustrated alongside one another, which temporally succeed one another in FIG. 13. In the first block on the left, all the light emitting diodes are switched off during the first PWM cycle formed by the first block. At the end of the first cycle, that is to say upon the transition to the second block, following the left block, all three light emitting diodes are switched on simultaneously. The switched-on state is present over seven cycles. As the eighth cycle, all three light emitting diodes are switched off simultaneously. This corresponds to a switch-on ratio of 87.5%. The second block is followed temporally by an identical second and third block. It can be discerned that the three light emitting diodes are switched on and off synchronously. The normalized current values present when averaged over the duration of each block are again indicated below the respective blocks.

FIG. 14 then shows a modification according to the invention with two intermediate images as pulse patterns that likewise represent a switch-on process like FIG. 13. The power assigned to the intermediate images is lower than the power in the switched-on state, wherein the power rises with each further intermediate image, such that a substantially staircase-like profile of the power rise is the consequence.

In contrast to the switch-on process in accordance with FIG. 13, in the case of the switch-on process in accordance with FIG. 14, the three light emitting diodes are not switched on simultaneously all at once. The illustration in FIG. 14 corresponds in principle to the illustration in FIG. 13, for which reason reference is supplementarily made to FIG. 13 in this regard. Firstly, all three light emitting diodes are switched off over the entire PWM period in a left block in FIG. 14. In the transition from the left block to the block adjacent on the right, firstly only the topmost light emitting diode LED_0 is switched on, specifically with a duty ratio as in FIG. 13. Once again, as in FIG. 13, the average current normalized for this PWM cycle is illustrated below the block. A normalized current of 0.875 correspondingly results, since the light emitting diode LED_0 is switched on over seven of the eight periods of the PWM cycle. This operating state corresponds to a first intermediate image or first pulse pattern. This is followed directly by a subsequent block in which, in addition to the topmost light emitting diode LED_0, the middle light emitting diode LED_1 is now also activated simultaneously. This results in a further intermediate image. A corresponding current loading of 1.75 results. Finally, the fourth block follows, in which all three light emitting diodes are switched on synchronously. Correspondingly, the switched-on state as in FIG. 13 is now attained.

It can be seen from FIG. 14 that the switching-on sudden change in load, such as occurs in FIG. 13, can be reduced by the control in accordance with FIG. 14, that is to say sequential switching on of light emitting diodes. The loading, that is to say the current, changes its value in a steplike manner from 0 to the value in the switched-on state, specifically in accordance with the light emitting diode switched on in each subsequent cycle. In FIG. 14, the switch-on instants of the light emitting diodes are thus temporally shifted, specifically in each case by a PWM cycle in this exemplary embodiment. The sequential shift of the switch-on instants of the light emitting diodes is likewise realized by the clock generator 22 in the present case.

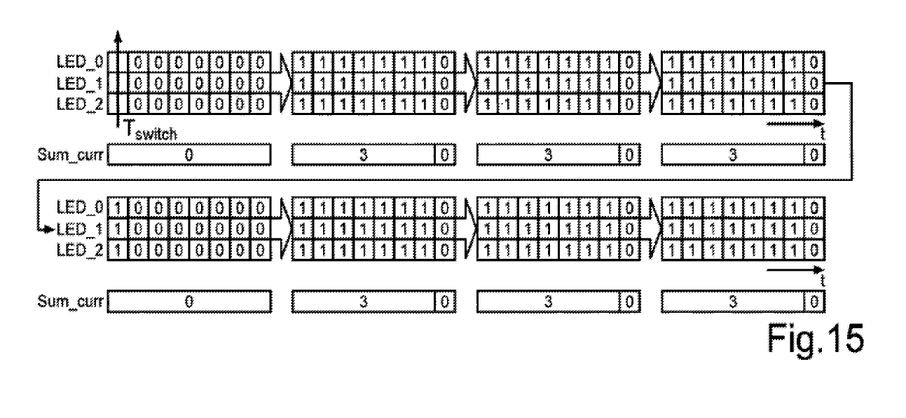

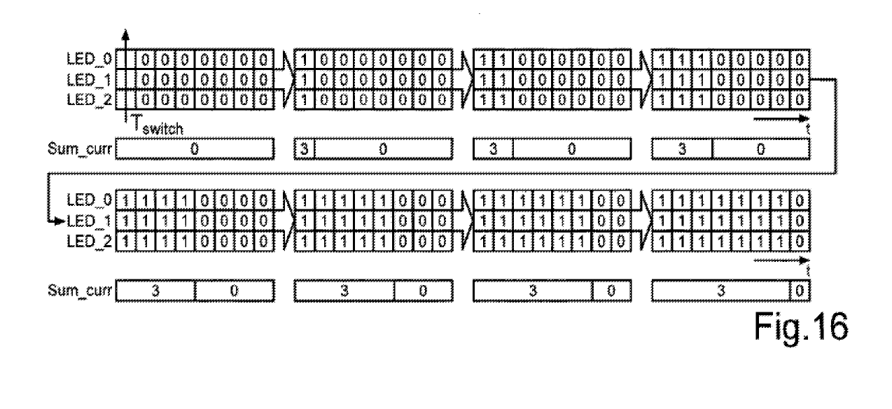

A further configuration of the invention is evident from FIGS. 15 and 16. The latter relate to the dimming of light emitting diodes of the illuminant 12 likewise on the basis of three selected light emitting diodes.

FIG. 15 shows a conventional switch-on process, of which eight PWM cycles that directly succeed one another are illustrated schematically in a logical block illustration. A respective normalized current sum is once again indicated below the respective blocks, wherein the normalized current sum here is related to the respective clock cycle in a cycle-related manner. It can be discerned that, as in FIG. 13, the first block on the left at the top in FIG. 15 is occupied by zeros, such that the light emitting diodes are switched off in this PWM cycle. Upon a change to the block disposed alongside on the right, all the light emitting diodes, as illustrated in FIG. 13, are switched on. The clock-related normalized current sum is therefore 3. Here, too, the power is set to 87.5% since the clock ratio of the PWM cycle is seven eighths. Six further, identical PWM cycles follow. With regard to the effects, reference is supplementarily made to the explanations concerning FIG. 13.

FIG. 16 then shows a switch-on process like FIG. 15, wherein here the three light emitting diodes are correspondingly dimmed. The upper block on the left is once again a switched-off PWM cycle, in which all three light emitting diodes are switched off. This is followed adjacently on the right by a block in which a switch-on process is initiated. It can be discerned that the three light emitting diodes are firstly switched on jointly for a first clock cycle of the PWM cycle, thus resulting in a first intermediate image. The light emitting diodes are switched off in the remaining seven clock cycles of the PWM cycle. This is followed adjacently on the right by a further block, in which the light emitting diodes are already switched on in two successive clock periods, thus resulting in a second intermediate image. For the remaining clock cycles of this PWM cycle, all three diodes are switched off again. This is followed adjacently on the right by a fourth PWM cycle, which begins with the three light emitting diodes being switched on over the first three clock cycles of the PWM cycle, thus resulting in a third intermediate image. Finally, this is followed directly by four further PWM cycles in a lower block illustration, in which the switched-on state is in each case lengthened by one clock cycle with the progressively advancing number of the PWM cycle and which form corresponding intermediate images. Finally, the switching state as in FIG. 13 in the right-hand block is attained in the block at the bottom right. An extreme sudden change in load can be avoided here, too, if the brightness values of the light emitting diodes can be interpolated or are dimmed. The dimming of the light emitting diodes can likewise be realized by the clock generator 22.

Of course, the exemplary embodiments described above can also be combined with one another in an expedient way in order to arrive at further configurations in the context of the invention.

One advantage of the technical features described is that a reduction of requirements made of the buck converter 14 can be achieved. As a result of the interpolation of image transitions or pulse patterns by means of intermediate values or adaptation of sudden load changes to a dynamic characteristic actually required, it is possible to reduce the dynamic characteristic of the current loading or power loading. The shift of PWM cycles of the individual light emitting diodes with respect to one another results in a reduction of the maximum summation current to be provided over the entire light emitting diode structure of the illuminant 12.

Both measures enable a more efficient design of the buck converter 14 because said converter need not map the complete dynamic characteristic of the system formed by the illuminant and a power reserve can be reduced. As a result, the complexity of the power electronics of the buck converter 14 can be reduced, as a result of which costs can be saved.

Furthermore, perturbing effects on an energy supply network or the electrical energy source can be reduced. In particular, filter complexity can be reduced.

Of course, individual features can be combined with one another in any desired manner as necessary in order to arrive at further configurations within the meaning of the invention. In particular, this of course concerns features of the dependent claims. Furthermore, of course, device features can be specified by corresponding method steps, and also vice versa.

Overall, the above description of the exemplary embodiments serves only for explaining the invention and is not intended to restrict the latter. It goes without saying that the person skilled in the art will provide corresponding variations as necessary, without departing from the central concept of the invention.

1. A control device for an illuminant comprising at least two semiconductor light sources and connectable to an electrical energy source, for converting an electrical power provided by the electrical energy source, by means of the semiconductor light sources, into an emitted light power dependent on the electrical power provided, wherein the semiconductor light sources are connected to the control device, and the control device is designed to set the electrical power provided by virtue of the control device comprising a clock generator designed to apply electrical power to the semiconductor light sources in clocked operation and to control said semiconductor light sources in accordance with clock pulse sequences individually assigned to the semiconductor light sources, wherein the clock generator is designed to form a common pulse pattern from the clock pulse sequences and to set the light power emitted by the illuminant by selecting a pulse pattern assigned to the light power.

2. The control device as claimed in claim 1, further comprising an electronic clocked energy converter controllable by means of the control device.

3. The control device as claimed in claim 1, wherein the semiconductor light source comprises a light emitting diode or a laser diode.

4. A lighting apparatus having an illuminant comprising a plurality of semiconductor light sources, an electrical terminal for connecting the lighting apparatus to an electrical energy source, and a control device, to which the semiconductor light sources are connected, the control device comprising at least two semiconductor light sources and connectable to an electrical energy source, for converting an electrical power provided by the electrical energy source, by means of the semiconductor light sources, into an emitted light power dependent on the electrical power provided, wherein the semiconductor light sources are connected to the control device, and the control device is designed to set the electrical power provided by virtue of the control device comprising a clock generator designed to apply electrical power to the semiconductor light sources in clocked operation and to control said semiconductor light sources in accordance with clock pulse sequences individually assigned to the semiconductor light sources, wherein the clock generator is designed to form a common pulse pattern from the clock pulse sequences and to set the light power emitted by the illuminant by selecting a pulse pattern assigned to the light power.

5. A method for controlling an illuminant comprising at least two semiconductor light sources and connected to an electrical energy source, wherein
the illuminant converts an electrical power provided by the electrical energy source, by means of the semiconductor light sources, into an emitted light power dependent on the electrical power provided,
the electrical power provided is set by means of a control device by virtue of electrical power being applied to the semiconductor light sources in clocked operation by means of the control device,
the semiconductor light sources are controlled in accordance with clock pulse sequences individually assigned to the semiconductor light sources,
wherein the clock pulse sequences form a common pulse pattern and the light power emitted by the illuminant is set by the selection of a pulse pattern assigned to the light power.

6. The method as claimed in claim 5, wherein switching over from a first pulse pattern assigned to a first emitted light power to a second pulse pattern assigned to a second emitted light power is carried out for the purpose of changing the light power emitted by the illuminant.

7. The method as claimed in claim 6, wherein switching over from the first to the second pulse pattern comprises interposing at least one third pulse pattern assigned to a light power between the first light power and the second light power.

8. The method as claimed in claim 5, wherein clock pulses of a first clock pulse sequence are temporally shifted with respect to clock pulses of a second clock pulse sequence.

9. The method as claimed in claim 5, wherein the clock pulses of a first clock pulse sequence lie in clock pauses of a second clock pulse sequence.

10. The method as claimed in claim 8, wherein in each case a clock pulse of the second clock pulse sequence is temporally directly adjacent to a clock pulse of the first clock pulse sequence.

11. The method as claimed in claim 8, wherein the clock pulses of the first clock pulse sequence last for a time duration that deviates from the clock pulses of the second clock pulse sequence.

12. The method as claimed in claim 5, wherein the electrical power provided by the electrical energy source is converted by means of an electronic clocked energy converter, wherein the electronic clocked energy converter is controlled proactively by means of the control device.

13. The method as claimed in claim 12, wherein the proactive control comprises communicating a suitable control signal to the electronic clocked energy converter before a clock pulse sequence and/or a pulse pattern are/is activated by means of the control device.

14. (canceled)
